(19) United States
(12) Patent Application Publication
(10) Pub. No.: US 2026/0146178 A1
(43) Pub. Date: May 28, 2026

(54) COMB POLYMERS

(71) Applicant: NOURYON CHEMICALS INTERNATIONAL B.V., Amsterdam (NL)

(72) Inventors: Klin Aloysius RODRIGUES, Signal Mountain, TN (US); Qingwen Wendy YUAN-HUFFMAN, Belle Mead, NJ (US); Jobie Lebron JONES, Ringgold, GA (US); Luis Gustavo FAVARO GOUVEA, Londrina (BR); Bruna Lilian BURGER, Campinas (BR); Malin Anita JOHANSSON, Göteborg (SE); Celia Regina Szcypula BUONO, Bradenton, FL (US); Kaaliyah Sadiyyah WILSON, Dunellen, NJ (US)

(73) Assignee: NOURYON CHEMICALS INTERNATIONAL B.V., Amsterdam (NL)

(21) Appl. No.: 19/120,934

(22) PCT Filed: Oct. 12, 2023
(86) PCT No.: PCT/EP2023/078411

§ 371 Date: Apr. 14, 2025

Related U.S. Application Data
(60) Provisional application No. 63/416,236, filed on Oct. 14, 2022.
(60) Provisional application No. 63/498,296, filed on Apr. 26, 2023.

(51) Int. Cl. C09D 133/06; A01N 25/30; C09D 5/02; C09D 5/14; C09D 7/65

(52) U.S. Cl. CPC C09D 133/064; A01N 25/30; C09D 5/027; C09D 5/14; C09D 7/65

(57) ABSTRACT

A dispersant polymer has the formula (I):

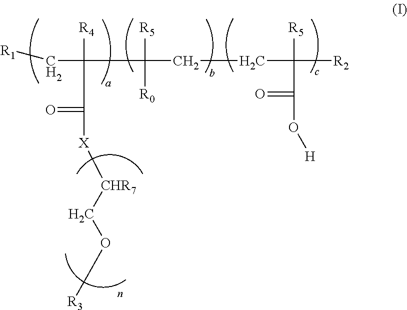

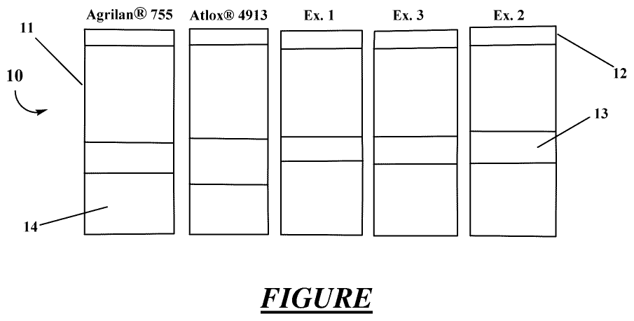

and can be used to stabilize a variety of formulations, particularly suspension concentrates.

### CROSS-REFERENCE TO RELATED APPLICATIONS

This application is a U.S. National-Stage entry under 35 U.S.C. § 371 based on International Application No. PCT/EP2023/078411, filed Oct. 12, 2023, which was published under PCT Article 21(2) and which claims the benefit of U.S. Provisional Application No. 63/416,236, filed Oct. 14, 2022, and U.S. Provisional Application No. 63/498,296, filed Apr. 26, 2023, each of which are expressly incorporated herein in their entireties by reference.

### FIELD OF THE DISCLOSURE

The present disclosure relates to polymers useful as dispersants and to formulations comprising the polymers.

### BACKGROUND

Dispersants are utilized to stabilize a wide variety of formulations. For example, so-called “comb polymers” are used for this purpose and are able to stabilize agrochemical formulations by adsorbing to particles or droplets in suspension concentrates (SC), suspo-emulsions (SE), and oil-in-water formulations.

Atlox® 4913, available from Croda, is a methylmethacrylate polyethylene glycol graft comb copolymer utilized as a dispersant in such agrochemical formulations. The copolymer is typically prepared by transesterification of a methylmethacrylate polymer with methoxy polyethylene glycol.

Agrilan® 755, available from Nouryon, is another methylmethacrylate polyethylene glycol graft comb copolymer utilized as a dispersant in agrochemical formulations.

Despite the availability of these materials, there remains a need for better performance in suspending and dispersing actives in agrochemical and other formulations, particularly in suspension concentrate formulations. In addition, other objects, desirable features and characteristics will become apparent from the subsequent summary and detailed description, and the appended claims, taken in conjunction with the accompanying drawings and this background.

### SUMMARY

The present disclosure relates in one embodiment to a polymer having the formula (I):

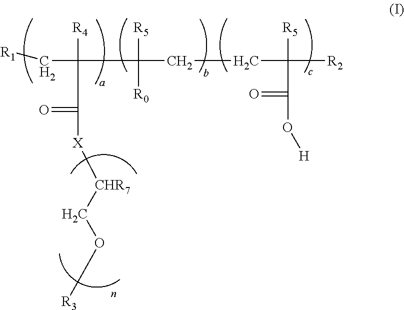

wherein
a is 1-25 mol %;
b is 50-95 mol %;
c is 0-25 mol %;
a+b+c=100 mol %;
n is 1-100, wherein when n is >1, then the individual —O—CH₂—CHR₇— groups may be the same or different;
X is O or NH, and is typically O;
R₀ is —C═OOR₆ or aryl, wherein aryl is typically —C₆H₅;
R₁ is an end group derived from a water-soluble initiating system;
R₂ is H, C₁-C₁₀hydrocarbyl, or an end group derived from a water-soluble initiating system or a chain transfer agent;
R₃ is H or C₁-C₂₂ hydrocarbyl;
R₄ is H or CH₃;
R₅ is H or CH₃;
R₆ is H or C₁-C₂₂ hydrocarbyl; and
R₇ is H or C₁-C₁₀ hydrocarbyl.

The present disclosure relates in a second embodiment to a process for preparing a polymer having the formula (I):

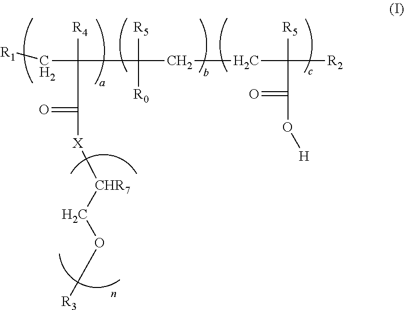

wherein
a is 1-25 mol %;
b is 50-95 mol %;
c is 0-25 mol %;
a+b+c=100 mol %;
n is 1-100, wherein when n is >1, then the individual —O—CH₂—CHR₇— groups may be the same or different;
X is O or NH, and is typically O;
R₀ is —C═OOR₆ or aryl, wherein aryl is typically —C₆H₅;
R₁ is an end group derived from a water-soluble initiating system;
R₂ is H, C1-10 hydrocarbyl, or an end group derived from a water-soluble initiating system or a chain transfer agent;
R₃ is H or C1-C22 hydrocarbyl;
R₄ is H or CH3;
R₅ is H or CH3;
R₆ is H or C1-C22 hydrocarbyl; and
R₇ is H or C1-10 hydrocarbyl;
the process comprising:
(a) introducing monomers a, b, and c to a reactor under starve-fed conditions,
wherein monomer a has the formula:

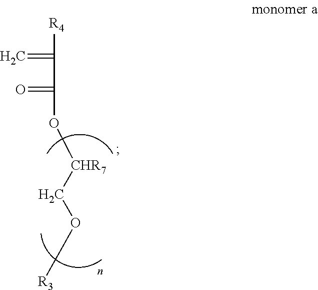

monomer b has the formula:

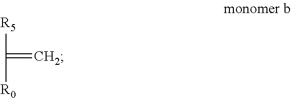

and monomer c has the formula:

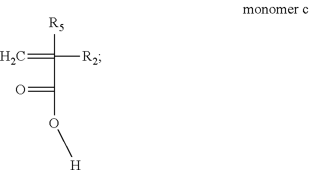

wherein each of monomer a, monomer b, and monomer c are introduced to the reactor in a molar ratio of a:b:c of 1-25:50-95:0-25, wherein at all times of the process such molar ratio is substantially unchanging and a total molar ratio of a+b+c=100 mol %; and
(b) obtaining as a result of (a) the polymer of the formula (I).

The disclosure relates in a third embodiment to a polymer prepared according to the disclosed process.

The disclosure relates in a fourth embodiment to a formulation comprising at least one active ingredient dispersed in an effective dispersant amount of at least one disclosed polymer.

The method relates in a fifth embodiment to a method of combatting fungi comprising applying to the fungi or to a locus from which it is desired to exclude fungi a fungicidally effective amount of a formulation as described herein.

The method relates in a sixth embodiment to a method of combatting insects comprising applying to the insects or to a locus from which it is desired to exclude insects an insecticidally effective amount of a formulation as described herein.

The method relates in a seventh embodiment to a method of combatting plants comprising applying to the plants or to a locus from which it is desired to exclude plants a herbicidally effective amount of a formulation as described herein.

The method relates in an eighth embodiment to a method of coating a surface comprising applying to the surface an amount effective to coat the surface of a formulation as described herein.

### BRIEF DESCRIPTION OF THE DRAWINGS

The disclosure will now be described in greater detail with reference to the drawings, wherein:

The FIGURE is a diagram showing the phase separation of a formulation spiked with various dispersant polymers as set forth in the Examples.

### DETAILED DESCRIPTION

The following detailed description is merely exemplary in nature and is not intended to limit the current composition. Furthermore, there is no intention to be bound by any theory presented in the preceding background or the following detailed description. Moreover, it is contemplated that, in various non-limiting embodiments, it is to be appreciated that all numerical values as provided herein, save for the actual examples, are approximate values with endpoints or particular values intended to be read as “about” or “approximately” the value as recited.

Embodiments of the present disclosure are generally directed to polymers, compositions including the same, and methods for forming the same. For the sake of brevity, conventional techniques related to making polymers and such compositions may not be described in detail herein. Moreover, the various tasks and process steps described herein may be incorporated into a more comprehensive procedure or process having additional steps or functionality not described in detail herein. In particular, various steps in the manufacture of polymers and associated compositions are well-known and so, in the interest of brevity, many conventional steps will only be described briefly herein or will be omitted entirely without providing the well-known process details.

In this disclosure, the terminology “about” can describe values ±0.1, 0.5, 1, 2, 3, 4, 5, 6, 7, 8, 9, or 10%, in various embodiments. Moreover, it is contemplated that, in various non-limiting embodiments, it is to be appreciated that all numerical values as provided herein, save for the actual examples, are approximate values with endpoints or particular values intended to be read as “about” or “approximately” the value as recited. It is also contemplated that all isomers and chiral options for each compound described herein are hereby expressly contemplated for use herein in various non-limiting embodiments.

Throughout this disclosure, the terminology percent “actives” is well recognized in the art and means the percent amount of active or actual compound or molecule present as compared to, for example, a total weight of a diluted solution of a solvent and such a compound. Some compounds, such as a solvent, are not described relative to a percent actives because it is well known to be approximately 100% actives. Any one or more of the values described herein may be alternatively described as percent actives as would be understood by the skilled person.

In various embodiments, the terminology “free of” describes embodiments that include less than about 5, 4, 3, 2, 1, 0.5, or 0.1, weight percent (or weight percent actives) of the compound or element at issue using an appropriate weight basis as would be understood by one of skill in the art. In other embodiments, the terminology “free of” describes embodiments that have zero weight percent of the compound or element at issue.

The terminology “consists essentially of” may describe various non-limiting embodiments that are free of one or more optional compounds described herein and/or free of one or more polymers, surfactants, additives, solvents, etc.

It is to be understood that the subscripts of polymers are typically described as average values because the synthesis of polymers typically produces a distribution of various individual molecules.

The polymers and compositions disclosed herein may suitably comprise, consist of, or consist essentially of the components, elements, and process delineations described herein. The embodiments illustratively disclosed herein suitably may be practiced in the absence of any element which is not specifically disclosed herein.

It is an object of the present disclosure to provide polymers that provide improved performance in suspending and dispersing actives, particularly in suspension concentrate formulations.

It is also an object of the present disclosure to provide polymers that provide improved performance such as open time extension in aqueous coating formulations.

The present disclosure provides a polymer having the formula (I):

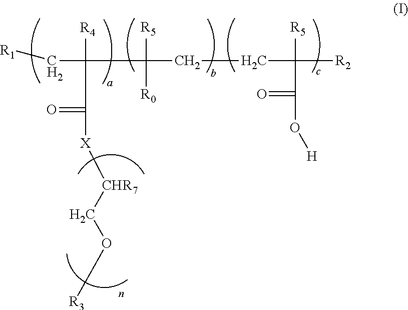

wherein
a is 1-25 mol %;
b is 50-95 mol %;
c is 0-25 mol %;
a+b+c=100 mol %;
n is 1-100, wherein when n is >1, then the individual —O—CH₂—CHR₇— groups may be the same or different;
X is O or NH, and is typically O;
R₀ is —C═OOR₆ or aryl, wherein aryl is typically —C₆H₅;
R₁ is an end group derived from a water-soluble initiating system;
R₂ is H, C₁-C₁₀hydrocarbyl, or an end group derived from a water-soluble initiating system or a chain transfer agent;
R₃ is H or C₁-C₂₂ hydrocarbyl;
R₄ is H or CH₃;
R₅ is H or CH₃;
R₆ is H or C₁-C₂₂ hydrocarbyl; and
R₇ is H or C₁-C₁₀ hydrocarbyl.

The present disclosure also provides a method of making the polymer that includes the steps of (a) introducing monomers a, b, and c to a reactor under starve-fed conditions, wherein monomer a has the formula:

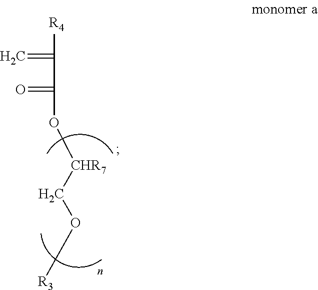

monomer b has the formula:

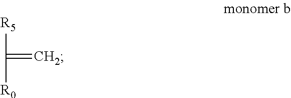

and monomer c has the formula:

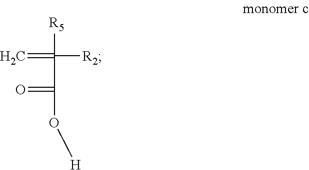

wherein each of monomer a, monomer b, and monomer c is introduced to the reactor in a molar ratio of a:b:c of 1-25:50-95:0-25, wherein at all times of the process such molar ratio is substantially unchanging and a total molar ratio of a+b+c=100 mol %; and
(b) obtaining as a result of the (a) polymer of the formula (I).

Atlox® 4913, available from Croda, is a methylmethacrylate polyethylene glycol graft comb copolymer believed to be prepared by transesterification of a methylmethacrylate polymer with methoxy polyethylene glycol. Without intending to be bound by theory, it is believed that a significant quantity of unbound methoxy polyethylene glycol is present in the product. Accordingly, the disclosed polymers of the formula (I) are typically prepared in such a way that significant quantities of this and other similar impurities are avoided.

Accordingly, in a typical embodiment, the polymer of formula (I) is substantially free of monomers of the formula (II):

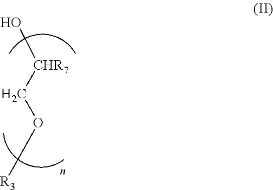

wherein
n is 1-100;
R3 is H or C1-C₂₂ hydrocarbyl; and
R7 is H or C1-10 hydrocarbyl.

The phrase “substantially free” as used herein as it relates to the compound of the formula (II) means the polymer contains less than 20% by weight, based on a total weight of the polymer, of the compound of the formula (II). Typically, the polymer contains less than 19% by weight, or less than 18% by weight, or less than 17% by weight, or less than 16% by weight, or less than 15% by weight, or less than 14% by weight, or less than 13% by weight, or less than 12% by weight, or less than 11% by weight, or less than 10% by weight, or less than 9% by weight, or less than 8% by weight, or less than 7% by weight, or less than 6% by weight, or less than 5% by weight, or less than 4% by weight, or less than 3% by weight, or less than 2% by weight, or less than 1.5% by weight, or less than 1% by weight, or is completely free of the compound of formula (II). Where the compound of formula (II) is methoxy polyethylene glycol, this means the polymer contains less than 20% by weight, or less than 19% by weight, or less than 18% by weight, or less than 17% by weight, or less than 16% by weight, or less than 15% by weight, or less than 14% by weight, or less than 13% by weight, or less than 12% by weight, or less than 11% by weight, or less than 10% by weight, or less than 9% by weight, or less than 8% by weight, or less than 7% by weight, or less than 6% by weight, or less than 5% by weight, or less than 4% by weight, or less than 3% by weight, or less than 2% by weight, or less than 1.5% by weight, or less than 1% by weight, or is completely free of methoxy polyethylene glycol.

The polymer compositions are typically prepared from a polymerization mixture in an aqueous medium in the presence of any initiator or initiating system capable of liberating free radicals under the reaction conditions employed. The free radical initiators are present in an amount ranging from about 0.01% to about 10 mol % based on total moles of monomer. In a typical embodiment, the initiating system is soluble in water to at least 0.1 weight percent, typically to at least 1 weight percent and most typically to at least 10 weight percent at 25° C. Suitable initiators include, but are not limited to, peroxides, azo initiators as well as redox systems, such as erythorbic acid, and metal ion based initiating systems. Initiators may also include both inorganic and organic peroxides, such as hydrogen peroxide, benzoyl peroxide, acetyl peroxide, and lauryl peroxide; organic hydroperoxides, such as cumene hydroperoxide and t-butyl hydroperoxide. In an embodiment, the inorganic peroxides, such as sodium persulfate, potassium persulfate and ammonium persulfate, are typical. In another embodiment, the initiators comprise metal ion based initiating systems including Fe and hydrogen peroxide, as well as Fe in combination with other peroxides. Organic peracids such as peracetic acid can be used. Peroxides and peracids can optionally be activated with reducing agents, such as sodium bisulfite, sodium formaldehyde, or ascorbic acid, transition metals, hydrazine, and the like. A typical system is persulfate alone such as sodium or ammonium persulfate or a redox system with iron and persulfate with hydrogen peroxide. Azo initiators, especially water-soluble azo initiators, may also be used. Water soluble azo initiators include, but are not limited to, 2,2′-Azobis[2-(2-imidazolin-2-yl)propane]dihydrochloride, 2,2′-Azobis[2-(2-imidazolin-2-yl)propane]disulfate dihydrate, 2,2′-Azobis(2-methylpropionamidine)dihydrochloride, 2,2′-Azobis [N-(2-carboxyethyl)-2-methylpropionamidine]hydrate, 2,2′-Azobis{2-1[1-(2-hydroxyethyl)-2-imidazolin-2-yl]propane}dihydrochloride, 2,2′-Azobis[2-(2-imidazolin-2-yl)propane], 2,2′-Azobis(1-imino-1-pyrrolidino-2-ethylpropane)dihydrochloride, 2,2′-Azobis{2-methyl-N-[1,1-bis(hydroxymethyl)-2-hydroxyethyl]propionamide}, 2,2′-Azobis[2-methyl-N-(2-hydroxyethyl)propionamide] and others.

The molecular weight of the polymers may be controlled by various compounds used in the art including, for example, chain transfer agents such as mercaptans, ferric and cupric salts, bisulfites, and lower secondary alcohols, typically isopropanol. The polymer starts to be more and more water insoluble as the content of monomer b increases over 75 mol %. Higher molecular weight polymers in this composition range tends to acerbate the water solubility. Therefore, it is important to use a chain transfer agent to minimize the effect on water solubility by lowering the molecular weight when b is >75 mol % or 79 mol % and therefore R₂ in this embodiment is derived from a chain transfer agent. For purposes of this disclosure the typical chain transfer agents are thiols such as 3-mercaptopropionic acid or 2-mercaptoethanol or lower secondary alcohols, typically isopropanol.

The phrase “starve-fed” as used herein means introducing monomers gradually to the reactor at a rate sufficiently slow enough that the majority of each monomer introduced is consumed by the reaction before additional monomer is added. In a typical embodiment, at least 50% of the monomers are consumed by the reaction before more monomers are added, or at least 55%, or at least 60%, or at least 65%, or at least 70%, or at least 75%, or at least 76%, or at least 77%, or at least 78%, or at least 79%, or at least 80%, or at least 81%, or at least 82%, or at least 83%, or at least 84%, or at least 85%, or at least 86%, or at least 87%, or at least 88%, or at least 89%, or at least 90%, or at least 91%, or at least 92%, or at least 93%, or at least 94%, or at least 95%, or at least 96%, or at least 97%, or at least 98%, or at least 99% of the monomers are consumed by the reaction before more monomers are added to the reactor.

That the feed molar ratio of monomers is “substantially unchanging” means the feed moles of each monomer is at all times within 10% by moles, typically 5% by moles, more typically 2% by moles, most typically 0.5% by moles of the anticipated final molar amount of that monomer in the final polymer.

In a typical embodiment, the polymer of formula (I) is one wherein
a is 3-18 mol %;
b is 60-90 mol %;
c is 2-20 mol %;
n is 2-25, wherein the individual —O—CH₂—CHR₇— groups may be the same or different;
X is O;
R₁ is an end group derived from a peroxide, persulfate, or azo initiator;
R₂ is H, CH₃, or an end group derived from an alcohol or glycol;
R₃ is H or CH₃;
R₄ is H or CH₃;
R₅ is H or CH₃;
R₆ is H or CH₃; and
R₇ is H or CH₃.

In a more typical embodiment, the polymer of formula (I) is one wherein
a is 6-14 mol %;
b is 70-85 mol %;
c is 5-15 mol %;
n is 5-15, wherein the individual —O—CH₂—CHR₇— groups may be the same or different;
X is O;
R₁ is an end group derived from a sodium or ammonium or potassium persulfate;
R₂ is H, CH₃, or an end group derived from isopropyl alcohol or propylene glycol or a thiol chain transfer agent such 3-mercaptopropionic acid or 2-mercaptoethanol;
R₃ is H or CH₃;
R₄ is H or CH₃;
R₅ is H or CH₃;
R₆ is H or CH₃; and
R₇ is H or CH₃.

In one embodiment, the polymer of formula (I) is derived from methoxy polyethylene glycol methacrylate.

In a typical aspect of this embodiment, the compound of formula (II) is methoxy polyethylene glycol.

In a more typical aspect of this embodiment, the polymer of formula (I) comprises less than 20% or less than 15% or less than 10% or less than 5% by weight of methoxy polyethylene glycol, based on a total weight of the polymer.

In a particularly typical embodiment, the polymer comprises (a) 75-85 mol % methylmethacrylate, (b) 10-15 mol % methoxy polyethylene glycol methacrylate, and (c) 5-10 mol % methacrylic acid, wherein (a)+(b)+(c)=100 mol %.

In an especially typical embodiment, the polymer comprises (a) 75-85 mol % methylmethacrylate, (b) 10-15 mol % methoxy polyethylene glycol methacrylate, and (c) 5-10 mol % methacrylic acid, wherein (a)+(b)+(c)=100 mol %, and comprises less than 10% or less than 5% or less than 2% or less than 1.5% or less than 1% by weight of methoxy polyethylene glycol, based on a total weight of the polymer.

In a most typical embodiment, the polymer is one prepared by the disclosed process under “starve-fed” conditions, comprises (a) 70-85 mol % methylmethacrylate, (b) 10-15 mol % methoxy polyethylene glycol methacrylate, and (c) 5-10 mol % methacrylic acid, wherein (a)+(b)+(c)=100 mol %, and comprises less than 10% or less than 5% or less than 2% or less than 1.5% or less than 1% by weight of methoxy polyethylene glycol, based on a total weight of the polymer.

In an embodiment, the disclosure relates to a formulation comprising a formulation carrier, at least one active ingredient that is effective for an intended end use, an effective dispersant amount of at least one disclosed polymer, and optionally one or more other ingredients customarily included in formulations intended for the end use.

In an embodiment, the at least one active ingredient is a water insoluble or immiscible material.

For the purposes of the present disclosure, a “water insoluble or immiscible material” is defined as any active material that has a solubility of less than 0.1 wt % in water.

In one typical embodiment, the disclosed formulation is an agrochemical formulation and the at least one active ingredient is an agrochemical active ingredient.

Agrochemical formulations disclosed herein comprise at least one agrochemical active ingredient and an effective dispersant amount of at least one of the disclosed polymers.

The term “effective dispersant amount” means an amount of the disclosed polymers which is effective to disperse the at least one active ingredient, for example, the at least one agrochemical ingredient, in a liquid carrier.

In a typical embodiment, the liquid carrier is typically water. However, an organic solvent can be added if desired.

In another typical embodiment, the liquid carrier is water alone or optionally in combination with an organic solvent, and the disclosed polymer is utilized in an amount of 0.1 to 20 wt %, 0.1 to 10 wt %, 0.1 to 5 wt %, in each case based on a total weight of the formulation, and this amount is effective to disperse the at least one agrochemical ingredient in the liquid carrier.

In yet another typical embodiment, the agrochemical active ingredient is selected from the group consisting of herbicides, insecticides, fungicides, biocides, molluscicides, algaecides, plant growth regulators, anthelmintics, rodenticides, nematocides, acaricides, amoebicides, protozoacides, crop safeners, and adjuvants.

Usually, the agrochemical active ingredient is water insoluble or immiscible.

Specific examples of useful agrochemical active ingredients include, without limitation:

Herbicides: including triazines such as Atrazine {6-chloro-N-ethyl-N′-(I-methylethyl)-1,3,5-triazine-2,4diamine, and Prometryn {N,N′-bis(1-methylethyl)-6(methylthio)-1,3,5-triazine)-2,4-diamine}, substituted ureas such as Diuron {N′-(3,4-dichlorophenyl)-N,Ndimethylurea}, sulphonyl ureas such as metsulfuron-methyl {2-[[[[(4-methoxy-6-methyl-1,3,5triazin-2-yl) amino]carbony1]amino]sulfony1]benzoate}, triasulfuron {2-(2chloroethoxy)-N-[[(4-methoxy-6-methyl-1,3,5-triazin-2-yl) amino]carbonyl]benzenesulfonamide}, tribenuron-methyl {methyl 2-[[[[(4-methoxy-6-methyl-I,3,5triazin-2-y1) methylamino]carbonyl]amino]sulfonyl]benzoate} and chlorsulfuron {2-chloro-N-[[(4-methoxy-6-methyl-1,3,5triazin-2-yl)amino]carbonyl]benzenesulfonamide}, bis-carbamates such as Phenmedipham {3-[(methoxycarbonyl) amino]phenyl (3-methylphenyl)carbamate}; triazolone such as Sulfentrazone;

Fungicides: including thiocarbamates, particularly alkylenebis(dithiocarbamate)s, such as Maneb {[1,2ethanediylbis-[carbamodithiato](2-)]manganese} and Mancozeb {[[1,2-ethanediyl-bis[carbamodithiato]](2-)]manganese mixture with [[1,2-ethanediylbis[carbamodithiato]](2-)]zinc}, strobilurins such as azoxystrobin {methyl (E)-2-[[6-(2-cyanophenoxy)-4pyrimidinyl]oxy]-a-(methoxymethylene)benzeneacetate}60 and kresoxim-methyl {(E)-a-(methoxyimino)-2-[(2methylphenoxy) methyl]benzeneacetic acid methyl ester}, dicarboximides such as iprodione {3-(3,5dichlorophenyl)Nisopropyl-2,4dioxo imidazolidine-1-carboxamide}; azoles such as propiconazole {1-[2-(2,4-dichloro-phenyl)-4-65 propyl-1,3-dioxolan-2-yl-methyl-1H-1,2,4-triazole}, and tebuconazole {(RS)-I-p-chlorophenyl-4,4-dimethyl-3-(IH1,2,4-triazole-1-ylmethyl)pentan-3-ol}; halophthalonitriles such as chiorothalonil {2,4,5,6-tetrachloro-1,3dicyanobenzene}; and inorganic fungicides such as Copper hydroxide {Cu(OH)2};

Insecticides: including benzoyl ureas such as Difiubenzuron {N-[[(4-chlorophenyl)amino]carbonyl]-2,6- 5difiuorobenzamide)}; and carbamates such as carbaryl {I-naphthyl methylcarbamate}; and Acaricides including: tetrazines such as Clofentezine {3,6-bis(2-chlorophenyl)-1,2,4,5-tetrazine}.

Among water soluble active materials, non-selective herbicides, particularly N-(phosphono-methyl)glycine type herbicides such as glyphosate and sulphosate {respectively the iso-propyl-amino and trimethylsulphonium salts of N-phosphonomethyl glycine} and phosphinyl amino acids such as glufosinate {2-amino-4-(hydroxymethylphosphinyl) butanoic acid}, particularly as the ammonium salt. Such water soluble actives can be used as the sole active material in water dispersible granules, but more usually, they will be used in combination with water insoluble or immiscible active materials in multi-active formulations.

The agrochemical active in many agricultural applications usually are hydrophobic or water insoluble in character and are, by necessity, often administered as finely divided solids suspended in aqueous media. The majority of these agrochemical actives are manufactured and marketed in concentrated form, possibly with the addition of other insoluble inert fillers, which are then diluted prior to application. For example, the agrochemical active is typically available in the form of a suspension concentrate (SC), wettable powder (WP), suspo emulsion (SE) or water dispersible granule (WDG). However, due to the generally hydrophobic nature of the agrochemical active, the addition of a suitable dispersant is essential in order to achieve a homogenous dispersion with a minimum of mixing, such as may be achieved readily by hand or with minimal mechanical mixing. Often, this is an especially challenging task since the water used is extremely hard and may have up to 1000 ppm of hardness as calcium carbonate. This requires that the dispersant be hard water tolerant. Conventional dispersants do not perform under these tough conditions. Furthermore, once a homogenous dispersion is achieved, the resulting suspension must remain stable for a time sufficient, at least, to allow application by usual techniques such as spraying. Any settling, agglomeration or flocculation of the finely divided solid may lead to inconsistent and ineffective application as well as blockage of the spraying equipment. It is therefore necessary to provide a dispersant which provides easy and homogenous dispersion and results in a suspension which maintains its stability during the application of the aqueous dispersion, especially in hard water conditions.

In agrochemical applications, a wide variety of insoluble materials such as agrochemical actives are delivered in aqueous suspension. Active ingredients such as those used in WP, WDG, SE and SC formulations are generally insoluble in water at ambient temperatures. Water insoluble materials which may advantageously be used in WP, WDG, SE and SC formulations include herbicides, insecticides, fungicides, biocides, molluscicides, algaicides, plant growth regulators, anthelmintics, rodenticides, nematocides, acaricides, amoebicides, protozoacides, crop safeners and adjuvants. Examples of such agrochemical actives commonly granulated or made as powders in agriculture include: triazine herbicides such as simazine, atrazine, terbuthylazine, terbutryn, prometryn and ametryn, urea herbicides such as diuron and fiuometron, sulphonyl urea herbicides such as chlorsulfuron, metsulfuron methyl, nicosulfuron and triasulfuron, sulphonanilide herbicides such as fiumetsulam, triazolone herbicides such as sulfentrazone, organophosphate insecticides such as azinphos methyl, chlorpyrifos, sulprofos and azamethiphos, carbamate insecticides such as aldicarb, bendiocarb, carbaryl and BPMC, synthetic pyrethroids such as bifenthrin, as well as various types of fungicides including dimethomorph, benomyl, carbendazim, mancozeb, triazoles such as hexaconazole and diniconazole, acaricides such as propargite. A list of such products can be drawn from the Pesticide Dictionary (contained in the Farm Chemicals Handbook) or the British Crop Protection Society: Pesticides Manual. In addition, some fertilizers and also water soluble active principles may use water dispersible formulations either by addition of inert carriers for convenience in handling or to aid in a controlled release formulation. A wide variety of other insoluble materials are used in agricultural applications including fillers and carriers, for example but not limited to, natural and synthetic silicates and silicate minerals, mineral oxides and hydroxides and also natural and synthetically derived organic materials. Such materials may be added as porous carriers, as moisture inhibition agents, to aid binding or agglomeration properties of a formulation or simply to fill a formulation to a convenient weight. Examples of such fillers may include natural silicates such as diatomacious earth, synthetic precipitated silicas, clays such as kaolin, attapulgites and bentonites, zeolites, titanium dioxide, iron oxides and hydroxides, aluminium oxides and hydroxides, or organic materials such as bagasse, charcoal, or synthetic organic polymers. These other insoluble materials may be readily dispersed in accordance with the present disclosure.

In addition to the disclosed dispersant polymer, the disclosed formulations may comprise a surfactant wetting agent. The role of the wetting agent in the case of SC formulations is to aid removal of air from particle surfaces during manufacture and to aid dilution in water. In the case of WP formulations the role of the wetter may be to aid penetration of the solids into water, while in the case of WDG formulations it may aid penetration of the granules into water and aid disintegration of granules back to primary particle size. In some cases the dispersant may itself function as a suitable wetting agent while in others the dispersant may show an antagonistic effect on the wetter.

The wetting agent may be anionic, cationic, nonionic, or amphiphilic, but is typically nonionic. Wetting agents of each of these types are well known in the art.

The surfactant wetting agent can be an alkyl or alkaryl sulfonates such as alkylbenzene sulfonates, alpha olefin sulfonate and alkyl naphthalene sulfonates. These surfactant wetting agents can be alkyl sulfates where the hydrophobe can be a linear or branched alcohol, an example being sodium lauryl sulfate. They may also be ethoxylated or non-ethoxylated alkyl or alkyaryl carboxylates as well as alkyl or alkyaryl phosphate esters. The surfactant wetting agent can be an alkylpolysaccharide; di or mono alkyl sulfosuccinate derivatives; a nonionic surfactant loaded onto an inert silicate carrier; and a non-ionic surfactant delivered in the form of a urea surfactant complex. The surfactant wetting agent could also include nonionic surfactants loaded onto a soluble organic or inorganic carrier or an anionic surfactant such as a sulfosuccinate that uses sodium benzoate as a carrier. The typical wetting agents are alpha olefin sulfonates, alkyl naphthalene sulfonates, dialkyl sulphosuccinates and combinations thereof.

Suitable wetting nonionic agents include Ethylan™ NS-500LQ, Ethylan™ 324, both of which are available from Nouryon; as well Atlox™ 4894, Terwet™ 1116, and Terwet™ 1118.

The disclosed formulation may also contain in addition to the disclosed dispersant polymer one or more additional dispersants. Such additional dispersants can be anionic, cationic, nonionic, or amphiphilic, but are typically anionic.

In a typical embodiment, the formulation further comprises at least one anionic dispersant.

In a more typical embodiment, the at least one anionic dispersant is selected from the group consisting of Morwet® D-360/D-390, Morwet® D-425, Agrilan® 789, Agrilan 785, Agrilan 788, and Agrilan 700, all of which are available from Nouryon; as well as Atlox™ 4913, Atlox™ 4915, Atlox™ 4917, Atlox™ 4919 (Croda), Tersperse™ 2500 (Indorama), Tersperse™ 2020, and Tersperse™ 2100.

The present disclosure is described with reference to WP, WDG, SE and SC formulations. In each case, formulations provide a stable aqueous dispersion of finely milled insoluble hydrophobic particles. The stability properties of the dispersion and hence the effectiveness of the dispersion can be measured by using a suspensibility test as described by the CIPAC test MT 15.1, 161 and 168. In this test the volume fraction of suspended material is compared to that which has settled out due to gravity after 30 minutes. Typically suspensibility about 70% would be considered as an effective dispersant for WDG and WP formulations, while in excess of 90% would be expected for an SC formulation. A typical measure for a WDG formulation is a suspensibility of 70% or greater in a system containing 1000 ppm water hardness as CaCO3. Another measure of the stability of the dispersion is the degree to which particles remain non-aggregated. This may also be a property of the even distribution of the dispersant in the formulation. The degree to which particles may be aggregated is often measured by a wet sieve retention test as described in CIPAC test MT 59.3. In this test the dispersed solid is poured through a series of fine sieves and retained material is measured as a fraction of the total amount of dispersed material. Formation of such aggregates is a major problem observed in WDG formulations and to a lesser extent in WP formulations.

Generally WP formulations are produced by milling the agrochemical active either alone or in combination with fillers, dispersants and/or surfactant wetters to a suitable particle size, typically in the 5-15 μm range. The milled material is then dry blended with a surfactant wetter, and/or dispersant if not already present or with additional dispersants and/or surfactant wetters to give a homogeneous composition. The powder formulation is assessed for wettability according to a method such as CIPAC MT 53.5.1 and suspensibility as per CIPAC MT 15.1. A formulation will desirably have a wettability of less than 1 minute and a suspensibility above 80%. Below 60% would generally be considered unacceptable. Results which might be commercially acceptable are either determined by the local registration authority or by the standards set by the formulators themselves.

In the case of WDG formulations a suitably milled active ingredient with or without other fillers, typically of particle size 5 to 15 μm, may be mixed with one or more surfactant wetters and one or more dispersants. Typically an excess of water is added to bind the particles together into agglomerates. The excess water is later reduced by suitable air drying techniques to an optimal level. The agglomerates are typically granulated using one of many techniques including pan granulation, drum granulation, fluid bed granulation, spray drying, tableting or extrusion techniques which are well known to those skilled in the art. The wetter and dispersant may either be powder blended with the active ingredient or alternatively blended as an aqueous solution in the water used to aid agglomeration. The active ingredient, fillers, wetter and dispersant may also be milled together in one operation prior to addition of water.

For a WDG formulation to be acceptable an additional requirement is that the granules should readily disperse in water back to the primary dispersed particle size within a short period. This property is known as dispersibility and in describing the current disclosure it is measured as the time taken for granules to disperse back to primary particle size in water under a standard degree of agitation. A dispersion time of less than one minute is desirable, 20 seconds is excellent and 2 minutes is poor. Desirably the granules should also have good suspensibility. Suspensibility is typically tested using CIPAC MT 15.1. Above 70% is a desirable result, less than 60% is generally regarded as undesirable. In many cases when testing granules a so-called maximum surface coverage result is often obtained. This is where the suspensibility results reach a maximum level then plateau. Adding more dispersant will not generally improve the result. This phenomenon is thought to be due to the particle size distribution of the material. Usually there are a given number of particles which are of such a size that they will settle regardless of type and concentration of dispersant. Desirably the granules should have low wet sieve retention. Wet sieve retention is typically tested using CIPAC MT 59.3. For the 150 um sieve less than 0.1% retained material is desirable. Less than 0.02% is more desirable. Likewise for the 53 um sieve less than 0.6% is desirable, anything less than this is more desirable.

A further desirable property of a WDG formulation is that the granules should be non-dusty and resistant to attrition. This is often a property of the method of granulation used and the level of compaction there obtained. Often there is an observed tradeoff between the dispersibility properties of a WDG formulation and the level of compaction and attrition resistance. Attrition resistance may be measured by subjecting granules to a set degree of agitation and measuring the level of smaller particles generated by passing through sieves of various sizes. Storage stability may be tested by storage at 50 degrees Celsius and tested as above at 1 month and 3 month intervals to determine if any properties have changed significantly.

As a further embodiment of the present disclosure in the case of WP and WDG formulations the dispersants herein described may be combined with surfactant wetting agents selected from the classes comprising alpha olefins sulfonate and their salts and alkyl naphthalene sulfonate and their salts, alkyl benzene sulfonates and their salts, alcohol sulfates and their salts, alkylpolysaccharides, nonionic surfactants loaded onto porous silicate carriers and urea surfactant complexes of non-ionic surfactants. The wetting agent may be combined in such formulations at a rate in excess of 1% w/w and typically less than 5% w/w. The typical wetting agents are alpha olefins sulfonate and their salts, alkyl naphthalene sulfonate and their salts, alkyl benzene sulfonates and their salts and alcohol sulfates and their salts. Examples of these include alpha olefins sulfonate and their salts such as Terwet 1004 from Huntsman and Witconate AOK from AkzoNobel Surface Chemistry with the most typical being the sodium or potassium salts of C₁₄-C₁₆ alkane hydroxy and C₁₄-C₁₆ alkene sulfonates, alkyl naphthalene sulfonate and their salts such as Morwet DB from AkzoNobel Surface Chemistry or Agnique ANS 3DNP-R from Cognis. The most typical being the butyl, dibutyl, isopropyl and diisopropyl naphthalene sulfonate salts. Examples of alkyl benzene sulfonates and their salts are Witconate 90 from AkzoNobel Surface Chemistry or Stepwet DF 90 from Stepan. The most typical being the salts of the C₁₂ alkyl benzene sulfonate or C₁₀-C₁₆ alkyl benzene sulfonate. Examples of alcohol sulfates and their salts are Stepwet DF-95 from Stepan or Agnique SLS 1295P from Cognis. The most typical being salts of lauryl or dodecyl alcohol sulfates.

Suspoemulsions (SE) include at least three phases: an aqueous phase, comprising an agrochemical active in solid dispersed form, and an organic phase comprising a second agrochemical active, either in liquid form or dissolved in an organic hydrophobic solvent. Normally the aqueous phase is the continuous phase. The second agrochemical active is typically water insoluble or immiscible. Liquid means that the active has a melting point of less than 30° C. The second agrochemical active which is liquid or soluble in a hydrophobic organic solvent, is an acetanilide derivative, such as alachlor, metolachlor or S-metolachlor (S-enantiomer of racemic metolachlor); typical are metolachlor and S-metolachlor. Suitable fungicides which can function as the second agrochemical active are for example benomyl, cyprodinil, dimethomorph, edifenphos, fenpropimorph, metalaxyl, (R)-metalaxyl (enantiomer). oxadixyl, pyrifenox, thiabendazol, tridemorph, azoxystrobin, kresoxim-methyl or triazoles such as propiconazol, difenoconazol, bromoconazol, cyproconazole, epoxyconazol, hexaconazol, ipconazol, fenbuconazol, myclobutanil, penconazol, tebuconazol, triadimefon, triadimenol, tetraconazol, triticonazol, or uniconazol; furtheron famoxadone, quinoxyfen, spiroxamin, fludioxonil, fenpiclonil, fenhexamid and 2-[a-{[(a-methyl-3-trifluoromethyl-benzyl) imino]-oxy}-o-tolyl]-glyoxylic acid-methylester-O-methyloxim. Suitable hydrophobic organic solvents in which the pesticides may be dissolved are aliphatic and aromatic hydrocarbons such as hexane, cyclohexane, benzene, toluene, xylene, mineral oil or kerosin, mixtures or substituted naphthalenes, mixtures of mono- and polyalkylated aromatics, halogenated hydrocarbons such as methylene chloride, chloroform and o-dichlorobenzene; phthalates, such as dibutyl phthalate or dioctyl phthalate; ethers and esters, such as ethylene glycol monomethyl or monoethyl ether, fatty acid esters; pyrrolinones, such as N-octylpyrrolidone, ketones, such as cyclohexanone; plant oils such as castor oil, soybean oil, cottonseed oil and possible methyl esters thereof; as well as epoxidised coconut oil or soybean oil.

In a most typical embodiment, the formulation is a suspension concentrate.

In one embodiment, the suspension concentrate comprises: (a) one or more active ingredients, (b) one or more inventive dispersant polymers, (c) one or more wetting agents, and (d) a liquid carrier. In addition, the suspension concentrate may optionally also contain antifreeze, antifoaming agents, rheology modifiers, and preservatives.

In the case of SC formulations in the present disclosure an active ingredient is typically added to water containing a dispersant, typically with a surfactant wetting agent together with a conventional non-ionic dispersant. A humectant may also be included. A dispersion is formed using high shear mixing. The dispersion is then milled by anyone of several techniques of wet milling so that the mean particle size of the dispersed solid is below 5 mm more typically in the range of from 1 to 3 mm. The resulting product is known as a millbase and may be modified with additives such as antifreeze, rheology modifiers and antisettling agents, biocides and coloring agents may be added. For an SC formulation to be acceptable it should not show a high degree of thickening, settling or growth of aggregates over time. These physical properties can be assessed by visual observation. SC's generally require good viscosity and storage stability. Storage stability is usually assessed as degree of top settling or syneresis, sedimenting or “claying” which is the tendency to form a sticky layer on the bottom and “bleeding” which is the tendency of the dispersion to separate without necessarily displaying even settling. Redispersibility is also important. These may also be assessed visually.

The suspension of insoluble material in aqueous medium will be typically used for the treatment of a substrate such as plant or other agricultural medium. The application of the suspension onto the substrate may be achieved by any convenient techniques, including spraying, and the like. Granules are generally dispersed in water prior to being sprayed by the farmer. Farm sprays may be as a small back-pack handspray or a large boom spray or other convenient techniques. Aerial spraying is also sometimes used. Formulations of the present disclosure may also be applied to the substrate directly, prior to dispersion. The subsequent application of rain or other aqueous media is sufficient for the formulation of the suspension of particulate material.

The step of dispersing the formulation in an aqueous medium may be achieved by any convenient techniques dependent on the nature of the formulation. It is desirable that the dispersion of the formulation in an aqueous solution may be conducted either by hand or with a minimum of mechanical agitation. Mechanical agitation may include stirring, mixing, blending and other similar processes.

### Additional Embodiments

In another typical embodiment, the formulation is a paint dispersion and the at least one active ingredient is a pigment.

Suitable pigments include inorganic pigments like titanium dioxide, coated titanium dioxide, titania, iron oxides (red, yellow, brown and black), zinc oxide, chrome pigment, ultramarine pigments, cobalt pigments (cobalt blue) and organic pigments like e.g. azo pigments. In a typical embodiment, the polymers of this disclosure disperse titanium dioxide leading to better hiding than conventional dispersants or less titanium dioxide can be used in the formulation to give the same amount of hiding.

Examples of suitable organic color pigments are: monoazo pigments: C.I. Pigment Brown 25; C.I. Pigment Orange 5, 13, 36, 38, 64, and 67; C.I. Pigment Red 1, 2, 3, 4, 5, 8, 9, 12, 17, 22, 23, 31, 48:1, 48:2, 48:3, 48:4, 49, 49:1, 51:1, 52:1, 52:, 53, 53:1, 53:3, 57:1, 58:2, 58:4, 63, 112, 146, 148, 170, 175, 184, 185, 187, 191:1, 208, 210, 245, 247, and 251; C.I. Pigment Yellow 1, 3, 62, 65, 73, 74, 97, 120, 151, 154, 168, 181, 183, and 191; C.I. Pigment Violet 32; diazo pigments: C.I. Pigment Orange 16, 34, 44, and 72; C.I. Pigment Yellow 12, 13, 14, 16, 17, 81, 83, 106, 113, 126, 127, 155, 174, 176, 180, and 188; diazo condensation pigments: C.I. Pigment Yellow 93, 95, and 128; C.I. Pigment Red 144, 166, 214, 220, 221, 242, and 262; C.I. Pigment Brown 23 and 41; anthanthrone pigments: C.I. Pigment Red 168; anthraquinone pigments: C.I. Pigment Yellow 147, 177, and 199; C.I. Pigment Violet 31; anthrapyrimidine pigments: C.I. Pigment Yellow 108; quinacridone pigments: Pigment Orange 48 and 49; C.I. Pigment Red 122, 202, 206, and 209; C.I. Pigment Violet 19; quinophthalone pigments: C.I. Pigment Yellow 138; diketopyrrolopyrrole pigments: C.I. Pigment Orange 71, 73, and 81; C.I. Pigment Red 254, 255, 264, 270, and 272; dioxazine pigments: C.I. Pigment Violet 23 and 37; C.I. Pigment Blue 80; flavanthrone pigments: C.I. Pigment Yellow 24; indanthrone pigments: C.I. Pigment Blue 60 and 64; isoindoline pigments: C.I. Pigments Orange 61 and 69; C.I. Pigment Red 260; C.I. Pigment Yellow 139 and 185; isoindolinone pigments: C.I. Pigment Yellow 109, 110, and 173; isoviolanthrone pigments: C.I. Pigment Violet 31; metal complex pigments: C.I. Pigment Red 257; C.I. Pigment Yellow 117, 129, 150, 153, and 177; C.I. Pigment Green 8; perinone pigments: C.I. Pigment Orange 43; C.I. Pigment Red 194; perylene pigments: C.I. Pigment Black 31 and 32; C.I. Pigment Red 123, 149, 178, 179, 190, and 224; C.I. Pigment Violet 29; phthalocyanine pigments: C.I. Pigment Blue 15, 15:1, 15:2, 15:3, 15:4, 15:6, and 16; C.I. Pigment Green 7 and 36; pyranthrone pigments: C.I. Pigment Orange 51; C.I. Pigment Red 216; pyrazoloqui-nazolone pigments: C.I. Pigment Orange 67; C.I. Pigment Red 251; thioindigo pigments: C.I. Pigment Red 88 and 181; C.I. Pigment Violet 38; triarylcarbonium pigments: C.I. Pigment Blue 1, 61 and 62; C.I. Pigment Green 1; C.I. Pigment Red 81, 81:1, and 169; C.I. Pigment Violet 1, 2, 3, and 27; C.I. Pigment Black 1 (aniline black); C.I. Pigment Yellow 101 (aldazine yellow); C.I. Pigment Brown 22.

Examples of suitable inorganic color pigments are: white pigments: titanium dioxide (C.I. Pigment White 6), zinc white, pigment grade zinc oxide; zinc sulfide, litho-pone; black pigments: iron oxide black (C.I. Pigment Black 11), iron manganese black, spinel black (C.I. Pigment Black 27); carbon black (C.I. Pigment Black 7); chromatic pigments: chromium oxide, chromium oxide hydrate green; chrome green (C.I. Pigment Green 48); cobalt green (C.I. Pigment Green 50); ultramarine green; cobalt blue (C.I. Pigment Blue 28 and 36; C.I. Pigment Blue 72); ultramarine blue; manganese blue; ultramarine violet; cobalt violet; manganese violet; red iron oxide (C.I. Pigment Red 101); cadmium sulfoselenide (C.I. Pigment Red 108); cerium sulfide (C.I. Pigment Red 265); molybdate red (C. I. Pigment Red 104); ultramarine red; brown iron oxide (C.I. Pigment Brown 6 and 7), mixed brown, spinel phases and corundum phases (C.I. Pigment Brown 29, 31, 33, 34, 35, 37, 39, and 40), chromium titanium yellow (C.I. Pigment Brown 24), chrome orange; cerium sulfide (C.I. Pigment Orange 75); yellow iron oxide (C.I. Pigment Yellow 42); nickel titanium yellow (C.I. Pigment Yellow 53; C.I. Pigment Yellow 157, 158, 159, 160, 161, 162, 163, 164, and 189); chromium titanium yellow; spinel phases (C.I. Pigment Yellow 119); cadmium sulfide and cadmium zinc sulfide (C.I. Pigment Yellow 37 and 35); chrome yellow (C.I. Pigment Yellow 34); bismuth vanadate (C.I. Pigment Yellow 184).

Formulations comprising a high proportion of pigment, i.e. pigment concentrates, are typical, because such formulations are particularly effective in providing color and hiding to paints. The pigment concentrates generally comprise 5 to 85% by weight, typically 20 to 75% by weight of pigment, based on the total weight of the pigment concentrate.

Typically, a pigment is added in an amount ranging from 5 to 40, most typically from 10 to 25 wt % based on the total weigh of the dispersion.

The formulation suitably comprises up to 100% by weight, typically 0.01 to 10% by weight, and most typically 0.1 to 5% by weight of the dispersant of the disclosure, calculated on the weight of the pigment. The most suitable amount of dispersant depends, among others, on the particular type of pigment to be dispersed.

In one typical embodiment, the disclosed formulation is a paint comprising (a) one or more pigments, (b) one or more binders, (c) one or more rheology modifiers, (d) one or more of the inventive dispersant polymers, and (e) a liquid carrier.

The polymers of this disclosure can be used as dispersants in decorative paint composition as well as aqueous paper coating compositions. These polymers can be used in paint formulations that are water borne flat, semi-flat, semi-gloss, and gloss paint compositions.

The components of paint composition are typically a solvent, typically water, for latex paints, binder, pigment and extenders and additives. These binders are typically latex binders such as polyvinyl acetate, copolymers of vinyl acetate and acrylate, copolymers of vinyl acetate and ethylene, copolymers of vinyl acetate, ethylene, and vinyl chloride, and copolymers of styrene and acrylate. The latex binders are often stabilized with anionic surfactants.

Extenders are paint additives that are insoluble in the binder and water. They are added to modify the flow and mechanical properties of the paint as well as the permeability, gloss and levelling characteristics of the paint film. White extender pigments are added to paints to lower their cost or improve their properties. This class includes calcium carbonate, calcium sulfate, diatomaceous silica, and china clays.

Additives include rheology modifiers and opaque polymers. The rheology modifiers include cellulosic derivatives, hydrophobically modified alkali swellable polymers, inorganic material such as clays and Nonionic Polyurethane Associative Thickeners (HEUR's) and similar materials.

The formulation may optionally comprise other known additives, such as additional dispersing agents, anti-foaming agents, biocides, pH control agents, wetting agents, materials to improve freeze thaw stability, leveling aids, coalescing agents and/or polymeric or oligomeric binders.

The pigment particles within the formulation are generally present in finely divided form. Accordingly, the pigments typically have average particle sizes within the range of 50 nm to 5,000 nm. Typically, the average particle size is at least 80 nm, more typically at least 100 nm. It is preferable that the average particle size is at most 3,000 nm, more typically at most 1,500 nm, and most typically at most 1,000 nm.

The average particle size of the pigment particles within the preparation can for example be determined by electron microscopy. Since the average particle size of the pigments within the preparation is essentially the same as the average particle size of the pigments after they are stirred into a liquid, it is also possible to mix the pigment preparation with a liquid medium and to determine the average pigment particle size by dynamic light scattering.

In various embodiments, the polymers of this disclosure are used in aqueous coatings, adhesive and sealants and related formulations.

Aqueous coatings should have an acceptable balance of properties during the storage, application, and drying. During application, if irregularities arise, there is a finite amount of time in which such irregularities can be repaired without seeing brush marks. This time is known in the art as open time. Unfortunately, aqueous coatings typically use dispersed high molecular weight polymers as binders which tend to shorten open times because the dispersed polymer particles tend to be immobilized quickly at the edges of applied coatings. As a result, the viscosity of the coating increases rapidly, which leads to a limited window of workability, i.e., a shorter open time.

In typical coatings, the open time is increased by the addition of solvents and coalescing agents. However, this leads to an increase in the volatile organic content (VOC) of the coating which is undesirable. The polymers of this disclosure can be added to the paint formulation in the grind or as an additive in the letdown especially when used to control open time. In various embodiments, the polymers of this disclosure are additives that are not volatile yet still extend the time that the coating is workable after it is applied without interfering with other attributes.

The polymers of this disclosure can also be used as dispersants in paint formulations that increase open time and improve freeze thaw stability. These polymers can be used to formulate zero VOC architectural paints because the polymers may eliminate the need for glycol solvents used as open time extenders and coalescents. In some embodiments, these polymers can also reduce the amount of rheology modifier needed by anionic dispersants. In other embodiments, these polymers can also eliminate the need for a defoamer in the formulation. In other embodiments, these polymers may also work with most binder types such as acrylic, vinyl acrylate and styrene acrylates. Furthermore, the polymers of this disclosure can improve scrub resistance in certain formulations.

In addition, the polymers of this disclosure can be used as a colloid stabilizer during emulsion polymerization especially to produce emulsion binders used in coatings.

The disclosure will now be described in greater detail with reference to the following non-limiting examples.

### EXAMPLES

### Preparation of Polymers by Starve-Fed Method

### Example 1

An initial charge of 155.6 g of deionized water and 73.2 g of propylene glycol was added to a 2-liter glass reactor with inlet ports for an agitator, water cooled condenser, thermocouple, and adapters for the addition of monomer and initiator solutions. The reactor contents were heated to 80° C. A solution of 100 g of methoxy polyethylene glycol 750 methacrylate (Komerate A750M from Green Chemical in Korea) dissolved in 100 g of water was fed into the reactor over 1 hour. Simultaneously, a well-mixed solution of 76.8 g of methyl methacrylate, 6 g of methacrylic acid and 1.5 g of 3-mercapto propionic acid was added to the reactor over the same 1 hour period. An initiator solution of 2.3 grams of sodium persulfate was dissolved in 34.8 grams water was concurrently added, starting at the same time as the 2 previous solutions, for a period of 75 minutes. The reaction product was then held at 80° C. for 60 minutes. The reactor contents was then cooled to 650 C and 6.3 g of 50% aqueous solution of sodium hydroxide was then added. The final polymer had 80 mol % of methyl methacrylate, 12.75 mol % of methoxy polyethylene glycol 750 methacrylate (where n is approximately 15) and 7.25 mol % of methacrylic acid.

### Example 2

An initial charge of 180 g of deionized water and 100 g of isopropyl alcohol was added to a 2-liter glass reactor with inlet ports for an agitator, water cooled condenser, thermocouple, and adapters for the addition of monomer and initiator solutions. The reactor contents were heated to 80° C. A well-mixed homogeneous solution of 59 g of methoxy polyethylene glycol 750 methacrylate (Komerate A750M), 46.2 g of methyl methacrylate and 3.7 g of methacrylic acid was fed into the reactor over 2 hours. An initiator solution of 2.1 grams of sodium persulfate was dissolved in 60 grams water was concurrently added, starting at the same time as the mixed monomer solution, for a period of 135 minutes. The reaction product was then held at 80° C. for 60 minutes. 2.1 g of 50% aqueous solution of sodium hydroxide dissolved in 100 g of water was then added. The reactor was then set up for distillation and an azeotropic of 195 g of a mixture of water and isopropyl alcohol was then distilled. The final polymer had 80 mol % of methyl methacrylate, 12.5 mol % of methoxy polyethylene glycol 750 methacrylate (where n is approximately 15) and 7.5 mol % of methacrylic acid. The residual methoxy polyethylene glycol 750 was measured to be 3.8 weight % of the polymer as measured by NMR. In contrast, Atlox 4931 had 31.6 weight % unreacted methoxy polyethylene glycol 750 based on weight of polymer using the same method.

### Example 3

Analogously to Examples 1 and 2, another copolymer can be prepared comprising 80 mol % of methyl methacrylate, 12.5 mol % of methoxy polyethylene glycol methacrylate and 7.5 mol % of methacrylic acid.

The methoxy polyethylene glycol content in different batches of this particular polymer ranged from 1.3 to 3.5 wt %, based on a total weight of the polymer. In contrast, different batches of Atlox 4931 ranged from 22.9 to 28.3 wt %, again, based on a total weight of the polymer.

### Example 4

An initial charge of 210 g of deionized water, 90 g of propylene glycol, 9.6 g of methyl methacrylate and 89.6 g of methoxy polyethylene glycol 750 methacrylate was added to a 1-liter glass reactor with inlet ports for an agitator, water cooled condenser, thermocouple, and adapters for the addition of monomer and initiator solutions. The reactor contents were heated to 90° C. 81 g of methyl methacrylate was fed into the reactor over 50 minutes. An initiator solution of 7.2 g of sodium persulfate was dissolved in 90 grams water was concurrently added, starting at the same time as methyl methacrylate monomer, for a period of 60 minutes. The reaction product was then held at 90° C. for 300 minutes. 8.7 g of 50% aqueous solution of sodium hydroxide was then added. The final polymer had 78.8 mol % of methyl methacrylate, 10.4 mol % of methoxy polyethylene glycol 750 methacrylate (where n is approximately 15) and 10.8 mol % of methacrylic acid.

### Example 5

An initial charge of 54 g of propylene glycol was added to a 1-liter glass reactor with inlet ports for an agitator, water cooled condenser, thermocouple, and adapters for the addition of monomer and initiator solutions. The reactor contents were heated to 85 C. A well-mixed homogeneous solution of 54 g of methoxy polyethylene glycol 750 methacrylate, 48.5 g of methyl methacrylate and 6 g of methacrylic acid, 18.2 g of methyl ethyl ketone and 140 g of water was fed into the reactor over 50 minutes. An initiator solution of 2 grams of sodium persulfate was dissolved in 25 grams water was concurrently added, starting at the same time as the mixed monomer solution, for a period of 60 minutes. The reaction product was then held at 85° C. for 60 minutes. 5.5 g of 50% aqueous solution of sodium hydroxide dissolved in 100 g of water was then added. The final polymer had 78.3 mol % of methyl methacrylate, 10.4 mol % of methoxy polyethylene glycol 750 methacrylate (where n is approximately 15) and 11.3 mol % of methacrylic acid.

### Example 6

An initial charge of 176 g of deionized water and 96 g of isopropyl alcohol was added to a 2-liter glass reactor with inlet ports for an agitator, water cooled condenser, thermocouple, and adapters for the addition of monomer and initiator solutions. The reactor contents were heated to 82° C. 405 g of methoxy polyethylene glycol 750 methacrylate (Komerate A750M), was added to the reactor over 2 hours. A well mixed homogeneous solution of 25.8 g of styrene and 1.8 g of 3-mercapto propionic acid dissolved in 37.6 g of isopropyl alcohol was concurrently fed into the reactor over 2 hours starting at the same time as the previous feed. An initiator solution of 6 grams of ammonium persulfate was dissolved in 48 grams water was concurrently added, starting at the same time as afore mentioned solutions, for a period of 2.5 hours. The reaction product was then held at 85° C. for 60 minutes. The reactor was then set up for distillation and an azeotropic of 265 g of a mixture of water and isopropyl alcohol was then distilled. The final polymer had 50 mol % of styrene and 50 mol % of methoxy polyethylene glycol 750 methacrylate (where n is approximately 15.

### Polymer Evaluation

### Example 7: Suspensibility Testing

Various dispersant polymers were introduced to a 25% tebuconazole suspension concentrate formulation and the percent suspensibility of tebuconazole measured.

25 wt % tebuconazole suspension concentrate was made with the ingredients listed in the table. Suspensibility is measured based on CIPAC MT 184 standard, where a suspension concentrate was diluted 20 times into in 1000 ppm hard water, placed in a 250-liter measuring cylinder at 25° C., and allowed to remain undisturbed for 30 minutes. The top 9/10ths are drawn off and the remaining 1/10th was then assayed gravimetrically, and suspensibility calculated.

| | Wt % |
|---|---|
| Active Ingredient: Tebuconazole | 25.00% |
| Wetting Agent: Morwet EFW | 2.00% |
| Deformer: Agnique DFM 111S | 0.15% |
| Dispersant | 3.00% |
| Carrier: Water | 69.85% |

| Dispersant | % Suspensibility |
|---|---|
| Agrilan ® 755 | 80.97% |
| Atlox ® 4913 | 70.98% |
| Example 1 | 102.33% |
| Example 2 | 100.68% |
| Example 3 | 85.56% |

### Example 8: Formulation Stability Testing

Various dispersant polymers were introduced to a 25 wt % tebuconazole suspension concentrate formulation and the resulting formulation was aged for two weeks at 54° C. The phase separation of the various formulations is shown in the FIGURE. The FIGURE shows a series of experiments 10 carried out in five bottles 11 each fitted with a lid 12 and containing in each a sample formulation comprising in each case the dispersant indicated above each lid 11. It is seen that the formulation has separated into a liquid phase 13 and a solid phase 14. The extent of the separation is an indication of the dispersing and stabilizing power of the dispersant. It is clearly seen that the disclosed polymers provided significantly less formulation separation than either Agrilan® 755 or Atlox® 4913.

| | % (w/w) |
|---|---|
| Active Ingredient: Tebuconazole | 25.00 |
| Wetting Agent: Morwet EFW | 2.00 |
| Deformer: Agnique DFM 111S | 0.15 |
| Dispersant | 3.00 |
| Carrier: Water | 69.55 |
| Rheology Modifier: Xanthan | 0.3 |

### Example 9: Particle Size Stability Testing

Various dispersant polymers were introduced to a sulfentrazone suspension concentrate formulation as listed in table. Particle size of the suspension concentrate was measured by Malvern Mastersizer 3000, when the SC was freshly made at 25° C., and after they were aged for 2 weeks at 54° C. Inventive polymer (Example 3) showed unchanged particle size after aging, while Atlox 4913 showed much more significant increase in particle size.

The particle size change, if any, after aging from 2 weeks at 54° C. is regarded as a predictor of the stability of the formulation at room temperature of 1-2 years. Thus, an increase in particle size of greater than 10% in this aging test suggests the formulation would not be stable at room temperature for an extended period of time as the increase in particle size suggests the original particles are aggregating, forming larger particles.

As should be clear from the results provided for the inventive polymer of Example 3, the particle size is substantially unchanged in the aging test.

| | % (w/w) |
|---|---|
| Active Ingredient: Sulfentrazone | 45.65 |
| Dispersant | 3.00 |
| Wetting Agent: Ethylan NS 500 LQ | 2.00 |
| Anti-freezing: Propilenoglicol | 5.00 |
| Anti-foam | 0.20 |
| Carrier: Water | 43.85 |
| Rheology Modifier: Xanthan | 0.20 |
| Preservative | 0.10 |

| | D10 | D50 | D90 |
|---|---|---|---|
| Dispersant | (μm) | (μm) | (μm) |
| Atlox ® 4913 (25° C.) original | 0.61 | 2.08 | 5.12 |
| Atlox ® 4913 (54° C./2 wks) aged | 0.80 | 2.68 | 6.25 |
| Agrilan ® 755 (25° C.) | 0.93 | 2.90 | 6.55 |
| Agrilan ® 755 (54° C./2 wks) aged | 1.02 | 3.26 | 7.92 |
| Example 3 (25° C.) | 0.81 | 2.49 | 5.74 |
| Example 3 (54° C./2 wks) aged | 0.79 | 2.45 | 5.56 |

An initial charge of 399.4 g of deionized water and 399.3 g of isopropyl alcohol was added to a 2-liter glass reactor with inlet ports for an agitator, water cooled condenser, thermocouple, and adapters for the addition of monomer and initiator solutions. The reactor contents were heated to 80° C. A well-mixed homogeneous solution of 165.2 g of methoxy polyethylene glycol 750 methacrylate (Komerate A750M) was dissolved in 124.6 g of deionized water and then 46.2 g of methyl methacrylate and 3.7 g of methacrylic acid was added and mixed to form a homogeneous solution and then fed into the reactor over 120 minutes. An initiator solution of 6.1 grams of sodium persulfate was dissolved in 60 grams water was concurrently added, starting at the same time as the mixed monomer solution, for a period of 135 minutes. The reaction product was then held at 80° C. for 60 minutes. 6.0 g of 50% aqueous solution of sodium hydroxide dissolved in 55 g of water was then added. The reactor was then set up for distillation and an azeotropic of 718.7 g of a mixture of water and isopropyl alcohol was then distilled. 23.7 g of 50% aqueous solution of sodium hydroxide and 450 g of water was then added. The final polymer solution had 70 mol % of methyl methacrylate, 12.5 mol % of methoxy polyethylene glycol 750 methacrylate (where n is approximately 15) and 17.5 mol % of methacrylic acid with a pH of 7.4 and 32.4% solids.

### Example 11

An initial charge of 399.4 g of deionized water and 399.3 g of isopropyl alcohol was added to a 2-liter glass reactor with inlet ports for an agitator, water cooled condenser, thermocouple, and adapters for the addition of monomer and initiator solutions. The reactor contents were heated to 80° C. A well-mixed homogeneous solution of 165.3 g of methoxy polyethylene glycol 750 methacrylate (Komerate A750M) was dissolved in 124.6 g of deionized water and then 97 g of methyl methacrylate and 38.3 g of methacrylic acid was added and mixed to form a homogeneous solution and then fed into the reactor over 120 minutes. An initiator solution of 6.1 grams of sodium persulfate was dissolved in 55 grams water was concurrently added, starting at the same time as the mixed monomer solution, for a period of 135 minutes. The reaction product was then held at 80° C. for 60 minutes. The reactor was then set up for distillation and an azeotropic of 718.7 g of a mixture of water and isopropyl alcohol was then distilled. 37.4 g of 50% aqueous solution of sodium hydroxide and 450 g of water was then added. The final polymer solution had 60 mol % of methyl methacrylate, 12.5 mol % of methoxy polyethylene glycol 750 methacrylate (where n is approximately 15) and 27.5 mol % of methacrylic acid with a pH of 7.6 and 30.4% solids.

### Example 12

An initial charge of 399.4 g of deionized water and 399.3 g of isopropyl alcohol was added to a 2-liter glass reactor with inlet ports for an agitator, water cooled condenser, thermocouple, and adapters for the addition of monomer and initiator solutions. The reactor contents were heated to 80° C. A well-mixed homogeneous solution of 165.4 g of methoxy polyethylene glycol 750 methacrylate (Komerate A750M) was dissolved in 124.3 g of deionized water and then 81 g of methyl methacrylate and 52.1 g of methacrylic acid was added and mixed to form a homogeneous solution and then fed into the reactor over 120 minutes. An initiator solution of 6.0 grams of sodium persulfate was dissolved in 55 grams water was concurrently added, starting at the same time as the mixed monomer solution, for a period of 135 minutes. The reaction product was then held at 80° C. for 60 minutes. The reactor was then set up for distillation and an azeotropic of 718.7 g of a mixture of water and isopropyl alcohol was then distilled. 50.8 g of 50% aqueous solution of sodium hydroxide and 395 g of water was then added. The final polymer solution had 50 mol % of methyl methacrylate, 12.5 mol % of methoxy polyethylene glycol 750 methacrylate (where n is approximately 15) and 37.5 mol % of methacrylic acid with a pH of 8.land 31.6% solids.

### Example 13

An initial charge of 199.6 g of deionized water and 199.3 g of isopropyl alcohol was added to a 2-liter glass reactor with inlet ports for an agitator, water cooled condenser, thermocouple, and adapters for the addition of monomer and initiator solutions. The reactor contents were heated to 80° C. A well-mixed homogeneous solution of 217.7 g of methoxy polyethylene glycol 1000 methacrylate (50% in water, Bisomer S10W) and 65 g of methyl methacrylate and 5.3 g of methacrylic acid was added and mixed to form a homogeneous solution and then fed into the reactor over 120 minutes. An initiator solution of 3.5 grams of sodium persulfate was dissolved in 51.3 grams water was concurrently added, starting at the same time as the mixed monomer solution, for a period of 135 minutes. The reaction product was then held at 80° C. for 60 minutes. The reactor was then set up for distillation and an azeotropic of 360 g of a mixture of water and isopropyl alcohol was then distilled. 5.4 g of 50% aqueous solution of sodium hydroxide and 230 g of water was then added. The final polymer solution had 80 mol % of methyl methacrylate, 12.5 mol % of methoxy polyethylene glycol 1000 methacrylate (where n is approximately 23) and 7.5 mol % of methacrylic acid with a pH of 7.0 and 30.6% solids.

### Example 14

An initial charge of 128.3 g of deionized water and 128.7 g of isopropyl alcohol was added to a 2-liter glass reactor with inlet ports for an agitator, water cooled condenser, thermocouple, and adapters for the addition of monomer and initiator solutions. The reactor contents were heated to 80° C. A well-mixed homogeneous solution of 269.6 g of methoxy polyethylene glycol 1000 methacrylate (50% in water, Bisomer S20W) and 41.6 g of methyl methacrylate and 3.4 g of methacrylic acid was added and mixed to form a homogeneous solution and then fed into the reactor over 120 minutes. An initiator solution of 3.5 grams of sodium persulfate was dissolved in 43.0 grams water was concurrently added, starting at the same time as the mixed monomer solution, for a period of 135 minutes. The reaction product was then held at 80° C. for 60 minutes. The reactor was then set up for distillation and an azeotropic of 231 g of a mixture of water and isopropyl alcohol was then distilled. 3.4 g of 50% aqueous solution of sodium hydroxide and 230 g of water was then added. The final polymer solution had 80 mol % of methyl methacrylate, 12.5 mol % of methoxy polyethylene glycol 2000 methacrylate (where n is approximately 46) and 7.5 mol % of methacrylic acid with a pH of 6.1 and 30.9% solids.

### Example 15

An initial charge of 100 g of deionized water and 130 g of isopropyl alcohol was added to a glass reactor with inlet ports for an agitator, water cooled condenser, thermocouple, and adapters for the addition of monomer and initiator solutions. The reactor contents were heated to 82° C. A well-mixed homogeneous solution of 168.75 g of methoxy polyethylene glycol 750 methacrylate mixed with 169 g of water was added into the reactor over 135 minutes. A mixture of 9.26 g of styrene dissolved in 69 g of isopropyl alcohol was added concurrently hold the same period of time. An initiator solution of 5 grams of ammonium persulfate was dissolved in 40 grams water was concurrently added, starting at the same time as the mixed monomer solution, for a period of 165 minutes. The reaction product was then held at 82° C. for 60 minutes. The reactor was then set up for distillation and an azeotropic of 357 g of a mixture of water and isopropyl alcohol was then distilled. The final polymer solution had 30 mol % of styrene and 70 mol % of methoxy polyethylene glycol 750 methacrylate (where n is approximately 17) with a pH of 2.6 and 29.3% solids. In this example, a=30, b=70 and c=0.

### Example 16

The polymers of this disclosure were tested for open time extension and compared to a commercial dispersant polymer Alcosperse 787 from Nouryon in a high gloss styrene acrylate paint formulation below. The control formulation Example 15A has propylene glycol which extends the open time but contributes to the VOC. The formulations containing polymers of this disclosure did not have propylene glycol. Yet the open time of these formulations were longer than the control formulation with propylene glycol.

| | | Example number | | | | |
|---|---|---|---|---|---|---|
| | | Comparative 16A | | | | |
| Ingredients | Function | Control | 16B | 16C | 16D | 16E |
| Pigment Griding | | | | | | |
| Water | | 15 | 16 | 16 | 16 | 16 |
| Propylene Glycol | Open Time | 2.5 | | | | |
| | Extender | | | | | |
| Kathon LXE | In Can | 0.14 | 0.14 | 0.14 | 0.14 | 0.14 |
| | Preservative | | | | | |
| Ethylan 1005SA | Wetting | 0.16 | 0.16 | 0.16 | 0.16 | 0.16 |
| Bermocoll Prime 2500 | Thickener | 0.25 | 0.25 | 0.25 | 0.25 | 0.25 |
| AMP 95 | Neutralizer | 0.08 | 0.08 | 0.08 | 0.08 | 0.08 |
| Dispersant | | Alcosperse | Example | Example | Example | Example |
| | | 787 | 2 | 10 | 11 | 12 |
| Dispersant | Dispersant | 1.5 | 1.5 | 1.5 | 1.5 | 1.5 |
| R900 Tipure TiO₂ | Pigment | 15.3 | 15.3 | 15.3 | 15.3 | 15.3 |
| Hydragloss 90 CaCO₃ | Filler | 6.5 | 6.5 | 6.5 | 6.5 | 6.5 |
| Nicron S503 Talc | Extender | 6.5 | 6.5 | 6.5 | 6.5 | 6.5 |
| Total | | 47.93 | 46.43 | 46.43 | 46.43 | 46.43 |
| Letdown | | | | | | |
| BASF X4377 styrene | Binder | 44 | 44 | 44 | 44 | 44 |
| acrylic (50% solids) | | | | | | |
| Texanol | Coalescent | 0.7 | 0.7 | 0.7 | 0.7 | 0.7 |
| Acrysol RM 5000 | ICI Builder | 0.9 | 0.9 | 0.9 | 0.9 | 0.9 |
| Fennol Tech 2543 | Defoamer | 0.2 | 0.2 | 0.2 | 0.2 | 0.2 |
| Water | | 6.27 | 7.77 | 7.77 | 7.77 | 7.77 |
| Total | | 100 | 100 | 100 | 100 | 100 |
| Open time (minutes) | | 4 | 6 | 6 | 6 | 6 |

### Example 17

The polymers of this disclosure were tested for open time extension and compared to a commercial dispersant polymer Alcosperse 787 from Nouryon in a semi gloss styrene acrylate paint formulation below. The control formulation Example 16A has propylene glycol which extends the open time but contributes to the VOC. The formulations containing polymers of this disclosure did not have propylene glycol. However, the open time of these formulations were longer than the control formulation with propylene glycol.

| | | Example number | | | | |
|---|---|---|---|---|---|---|
| | | Comparative 17A | | | | |
| Ingredients | Function | Control | 17B | 17C | 17D | 17E |
| Pigment griding | | | | | | |
| Water | | 13 | 14.2 | 16 | 16 | 16 |
| Propylene Glycol | Open Time | 1.4 | | | | |
| | Extender | | | | | |
| Kathon LXE | In Can | 0.1 | 0.1 | 0.1 | 0.1 | 0.1 |
| | Preservative | | | | | |
| Ethylan 1005SA | Wetting Agent | 0.3 | 0.3 | 0.3 | 0.3 | 0.3 |
| Bermocoll Prime 2500 | Thickener | 0.2 | 0.2 | 0.2 | 0.2 | 0.2 |
| AMP 95 | Neutralizer | 0.1 | 0.1 | 0.1 | 0.1 | 0.1 |
| Dispersant | | Alcosperse | Example | Example | Example | Example |
| | | 787 | 2 | 10 | 11 | 12 |
| Dispersant | Dispersant | 1.75 | 1.75 | 1.75 | 1.75 | 1.75 |
| R900 Tipure TiO2 | Pigment | 6.8 | 6.8 | 6.8 | 6.8 | 6.8 |
| Hydragloss 90 CACO3 | Filler | 0.8 | 0.8 | 0.8 | 0.8 | 0.8 |
| Nicron S503 Talc | Extender | 4.5 | 4.5 | 4.5 | 4.5 | 4.5 |
| Total | | 45.5 | 45.5 | 45.5 | 45.5 | 45.5 |
| LETDOWN | | | | | | |
| BASF X4377 (50% | Binder | 53 | 53 | 53 | 53 | 53 |
| solids) | | | | | | |
| Texanol | Coalescent | 0.6 | 0.6 | 0.6 | 0.6 | 0.6 |
| Acrysol RM 5000 | ICI Builder | 0.2 | 0.2 | 0.2 | 0.2 | 0.2 |
| Fennol Tech 2543 | Defoamer | 0.1 | 0.1 | 0.1 | 0.1 | 0.1 |
| Water | | 0.6 | 0.6 | 0.6 | 0.6 | 0.6 |
| Total | | 100.0 | 100.0 | 100.0 | 100.0 | 100.0 |
| Open time (minutes) | | 4 | 6 | 6 | 6 | 6 |

The formulations 17B, D, E and F also passed through 5 freeze thaw cycles. One freeze thaw cycle involved storage in a freezer for 17 hours followed by 7 hours at room temperature. This is extremely unique since these formulations contain emulsion binders which form latex paints which are not freeze thaw stable. In addition, the formulations 17B, D, E and F did not exhibit any syneresis after 10 days storage at 60° C. which is very good performance since it predicts good formulation stability for several months at room temperature.

### Example 18

The following high gloss formulation was tested for open time and compared to Alcosperse 787 a commercial dispersant.

| | High Gloss | Semi Gloss | Satin |
|---|---|---|---|
| Ingredients | % | % | % |
| Pigment Grinding | | | |
| Water | 10.70 | 12.89 | 12.01 |
| In Can Preservative | 0.09 | 0.09 | 0.07 |
| Wetting Agent | 0.43 | 0.43 | 0.34 |
| Thickener | 0.15 | 0.15 | 0.17 |
| Neutralizer | 0.06 | 0.06 | 0.05 |
| Pigment Dispersant | 1.28 | 1.29 | 1.03 |
| Pigment TiO₂ | 22.5 | 21.49 | 22.31 |
| Filler CaCO₃ | | 4.30 | 6.86 |
| Extender Mica | | 1.07 | 0.86 |
| Extender Talc | | 5.37 | 8.58 |
| Total | 35.2 | 47.14 | 52.29 |
| Letdown | | | |
| Encor 636 Acrylic Binder | 59.91 | 53.7 | 46.3 |
| (50% Solids) | | | |
| HEUR ICI Builder | 0.43 | 0.43 | 0.34 |
| Wetting Agent Post Add | 0.21 | 0.21 | 0.17 |
| Water | 4.28 | 2.15 | 0.86 |
| Total | 100.0 | 100.0 | 100.0 |
| PVC | 16% | 25% | 35% |

As shown below, the open time results for the high gloss formulation below indicate that the polymers of this disclosure have significantly longer open times than the commercial dispersant. Even better improvement in open time and good freeze thaw stability results were obtained for the semi gloss formulations. Similar results in open time were also obtained for formulations containing a vinyl acrylate binder system. This indicates that the performance is independent of the type of binder.

| | | Open Time | Freeze Thaw |
|---|---|---|---|
| | | (Minutes) | Stability For 5 |
| Example | | High Gloss | Cycles For High |
| Number | Dispersant | Formulation | Gloss Formulation |
| 18A | Alcosperse 787 | 4 | |
| (comparative) | | | |
| 18B | Example 2 | 6 | Yes |
| 18C | Example 10 | 8 | Yes |
| 18D | Example 13 | 8 | Yes |
| 18E | Example 14 | 8 | Yes |
| | | Open Time | Freeze Thaw |
| | | (Minutes) | Stability For 5 |
| Example | | Semi Gloss | Cycles For Semi |
| Number | Dispersant | Formulation | Gloss Formulation |
| 18F | Alcosperse 787 | 6 | |
| (comparative) | | | |
| 18G | Example 2 | 10 | Yes |
| 18H | Example 10 | 14 | Yes |
| 18I | Example 13 | 14 | Yes |
| 18J | Example 14 | 18 | Yes |

### Example 19

An initial charge of 150.0 g of deionized water and 150.2 g of isopropyl alcohol was added to a glass reactor with inlet ports for an agitator, water cooled condenser, thermocouple, and adapters for the addition of monomer and initiator solutions. 0.0490 g of ferrous ammonium sulfate hexahydrate dissolved in 10 grams of water was then added to the reactor. The reactor contents are heated to reflux. A mixture of 59.2 grams of acrylic acid and 72.1 grams of styrene was added into the reactor over 210 minutes. A well-mixed homogeneous solution of 176.3 g of methoxy polyethylene glycol 750 methacrylate, 5.7 g of 3-mercaptopropionic acid dissolved in 140.3 grams of water was concurrently added into the reactor over 195 minutes. An initiator solution of 6.65 grams of sodium persulfate, 19.4 g of 35% hydrogen peroxide was dissolved in 80 grams water was concurrently added, for a period of 140 minutes. The reaction product was then held at 85° C. for 60 minutes. The reactor is then set up for distillation and an azeotropic of 300 g of a mixture of water and isopropyl alcohol is then distilled. Before the distillation, 0.1 g of Silicone S-100 was added. Before the distillation, 140 g of 50% aqueous solution of 2-amino-2-methyl-1-propanol and 300 g of water was added. The final product was an opaque white solution with a pH of 7.2 and a solids content of 37%.

This polymer can be used as a colloid stabilizer in emulsion polymerization reactions.

### Example 20

Example 19 was tested for hiding performance and compared to a commercial dispersant polymer Tamol 165A from Dow in an acrylate based paint formulation below. The grind and letdown materials are set forth below:

Grind Composition for Example 20

| Component | g |
|---|---|
| AMA-415 | 2.0 |
| BYK-022 | 1.0 |
| Dispersant: Example 19 or Tamol 165A | 4.0 |
| Surfactant: Ethylan 1005 | 2.0 |
| Neutralizer: AMP 95 | 1.0 |
| Titanium dioxide: Kronos 4311, 76% | 184.0 |
| Extender: Minex 4 | 17.5 |

Letdown Composition and Viscosity Data For Example 20

| Component | g |
|---|---|
| Grind: Grind Composition of Example 6 | 193.16 |
| Binder: Encor 636 | 281.6 |
| Defoamer: BYK-024 | 1.76 |
| Coalescent agent: Texanol | 14.08 |
| Rheology modifier: Acrysol RM 2020 | 9.0 |
| Water, adjustment | 31.08 |
| KU | 104.8 |
| ICI (P) | 1.39 |

The opacity was 100.6 compared to Tamol 165A in the same formulation which had a opacity of 98.5. This shows that the polymers of this disclosure improve hiding in paint formulations.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A polymer having the formula (I): 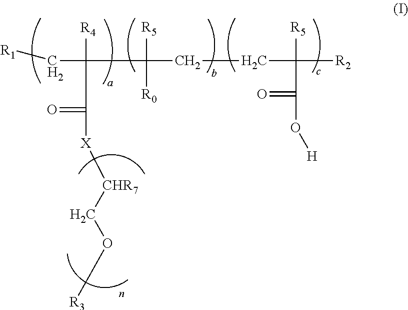
wherein
a is 1-25 mol %;
b is 50-95 mol %;
c is 0-25 mol %;
a+b+c=100 mol %;
n is 1-100, wherein when n is >1, then the individual —O—CH₂—CHR₇— groups are the same or different;
X is O or NH;
R₀ is —C═OOR₆ or aryl;
R₁ is an end group derived from a water-soluble initiating system;
R₂ is H, C₁-10 hydrocarbyl, or an end group derived from a water-soluble initiating system or a chain transfer agent;
R₃ is H or C1-C22 hydrocarbyl;
R₄ is H or CH3;
R₅ is H or CH3;
R₆ is H or C1-C22 hydrocarbyl; and
R₇ is H or C1-10 hydrocarbyl.

2. The polymer according to claim 1, wherein
a is 3-18 mol %;
b is 60-90 mol %;
c is 2-20 mol %;
n is 2-25, wherein the individual —O—CH₂—CHR₇— groups are the same or different;
X is O;
R₁ is an end group derived from a peroxide, persulfate, or azo initiator;
R₂ is H, CH3, or an end group derived from an alcohol or glycol;
R₃ is H or CH3;
R₄ is H or CH3;
R₅ is H or CH3;
R₆ is H or CH3; and
R₇ is H or CH3.

3. The polymer according to claim 1, wherein
a is 6-14 mol %;
b is 70-85 mol %;
c is 5-15 mol %;
n is 5-15, wherein the individual —O—CH₂—CHR₇— groups are the same or different;
X is O;
R₁ is an end group derived from a sodium or ammonium or potassium persulfate;
R₂ is H, CH3, or an end group derived from isopropyl alcohol or propylene glycol;
R₃ is H or CH3;
R₄ is H or CH3;
R₅ is H or CH3;
R₆ is H or CH3; and
R₇ is H or CH3.

4. The polymer according to claim 1, which is substantially free of a compound of the formula (II): 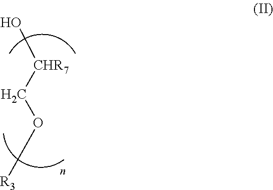
wherein
n is 1-100;
R3 is H or C1-C22 hydrocarbyl; and
R7 is H or C1-10 hydrocarbyl.

5. The polymer according to claim 4, wherein the compound of formula (II) is methoxy polyethylene glycol methacrylate.

6. The polymer according to claim 5, which comprises less than 10% by weight of methoxy polyethylene glycol methacrylate, based on a total weight of the polymer.

7. The polymer according to claim 1, which comprises (a) 75-85 mol % methylmethacrylate, (b) 10-15 mol % methoxy polyethylene glycol methacrylate, and (c) 5-10 mol % methacrylic acid, wherein (a)+(b)+(c)=100 mol %, and comprises less than 10% by weight of methoxy polyethylene glycol methacrylate, based on a total weight of the polymer.

8. A process for preparing a polymer having the formula (I): 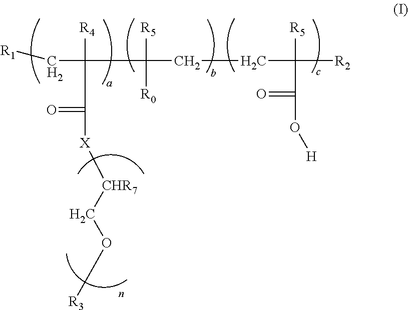
wherein
a is 1-25 mol %;
b is 50-95 mol %;
c is 0-25 mol %;
a+b+c=100 mol %;
n is 1-100, wherein when n is >1, then the individual —O—CH₂—CHR₇— groups are the same or different;
X is O or NH;
R₀ is —C═OOR₆ or aryl;
R₁ is an end group derived from a water-soluble initiating system;
R₂ is H, C1-10 hydrocarbyl, or an end group derived from a water-soluble initiating system or a chain transfer agent;
R₃ is H or C1-C22 hydrocarbyl;
R₄ is H or CH3;
R₅ is H or CH3;
R₆ is H or C1-C22 hydrocarbyl; and
R₇ is H or C1-10 hydrocarbyl;
said process comprising:
(a) introducing monomers a, b, and c to a reactor under starve-fed conditions, wherein monomer a has the formula: 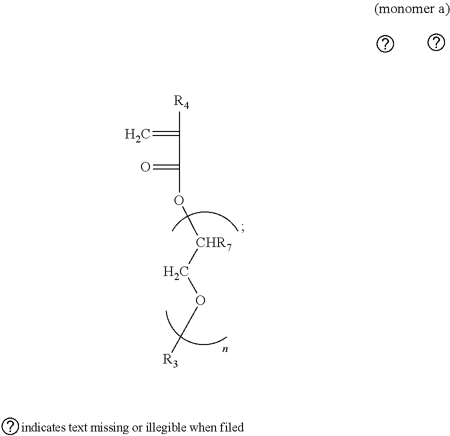
monomer b has the formula: 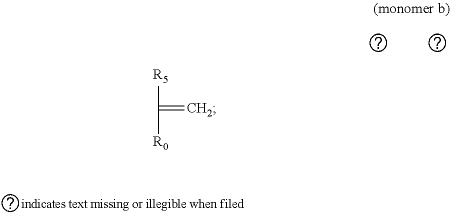
and monomer c has the formula: 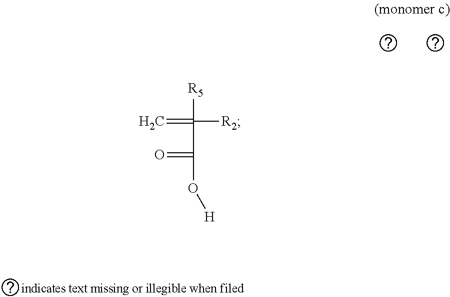
Wherein each of monomer a, monomer b, and monomer c is introduced to the reactor in a molar ratio of a:b:c of 1-25:50-95:1-25, wherein at all times of the process such molar ratio is substantially unchanging and a total molar ratio of a+b+c=100 mol %;
and
(b) obtaining as a result of (a) the polymer of the formula (I).

9. A polymer obtained by the process according to claim 8.

10. A formulation comprising at least one active ingredient dispersed in an effective dispersant amount of at least one polymer according to claim 1.

11. The formulation according to claim 10, which is an agrochemical formulation and the at least one active ingredient is an agrochemical active ingredient.

12. The formulation according to claim 11, wherein the agrochemical active ingredient is chosen from herbicides, insecticides, fungicides, biocides, molluscicides, algaecides, plant growth regulators, anthelmintics, rodenticides, nematocides, acaricides, amoebicides, protozoacides, crop safeners, adjuvants, and combinations thereof.

13. The formulation according to claim 10, which is a paint formulation and the at least one active ingredient is a pigment.

14. The formulation according to claim 10, which further comprises at least one anionic dispersant.

15. (canceled)

16. The formulation according to claim 10, which further comprises at least one nonionic dispersant.

17. (canceled)

18. The formulation according to claim 10, which is a suspension concentrate.

19. A method of combatting fungi comprising applying to the fungi or to a locus from which it is desired to exclude fungi a fungicidally effective amount of a formulation according to claim 10.

20. A method of combatting plants comprising applying to the plants or to a locus from which it is desired to exclude plants a herbicidally effective amount of a formulation according to claim 10.

21. A method of painting a surface comprising applying an amount sufficient to coat the surface of a formulation according to claim 13.
